(19) United States
(12) Patent Application Publication
(10) Pub. No.: US 2007/0125880 A1
(43) Pub. Date: Jun. 7, 2007

(54) Liquid atomizer unit having a double nozzle for fire extinction

(75) Inventor: Carsten Palle, Haarby (DK)

Correspondence Address: WILLIAM J. SAPONE;COLEMAN SUDOL SAPONE P.C., 714 COLORADO AVENUE, BRIDGE PORT, CT, 06605, US

(73) Assignee: VID ApS, Svendborg (DK)

(21) Appl. No.: 10/568,548

(22) PCT Filed: Aug. 19, 2004
(86) PCT No.: PCT/DK04/00549

§ 371 Date: Dec. 7, 2006

(30) Foreign Application Priority Data
Aug. 21, 2003 (DK) PA 2003 01191

(51) Int. Cl. B05B 7/04

(52) U.S. Cl. 239/398; 239/434

(57) ABSTRACT

When, according to the invention, a liquid atomizer unit for fire extinction is provided with a double nozzle system for liquid atomization and spreading of atomized liquid, where one nozzle is configured as a fully circular slot (14), and where the other nozzle is configured as a centrally arranged hole (17) having a baffle (18) disposed in the centre line in front of the nozzle hole (17), and where a mandrel is incorporated, extending through the cavity of the system, said mandrel (7) being penetrated by at least one slot or hole (11), all of which are arranged within the cavity, a high degree of projection is achieved for the sensitive parts of the unit, and moreover the coverage area of the water mist nozzle is optimum at a water pressure of between 200 and 2000 kPa.

### PRIOR ART

The invention relates to a liquid atomizer unit having a double nozzle system for fire extinction and comprising a cup with a bottom, said cup containing a mandrel which extends through the cavity of the cup, said mandrel comprising a centre hole as well as an end comprising an elevation with a central hole connecting the centre hole of the mandrel to the atmosphere, a baffle being arranged on the central shaft of the centre hole in front of and in parallel with the centre hole, said baffle being disposed on a leg and constituting, in combination with the centrally located hole, one nozzle of the liquid atomizer for liquid atomization.

Sprinkler and water mist systems for fire extinction are frequently constructed either as liquid-filled pipe systems where the nozzles are sealed by means of a gasket kept in place by a heat sensitive element which is decomposed by the heat from a fire, or as dry pipe systems with open nozzles through which the extinguisher may pass directly when being supplied to the pipe system.

The construction of nozzles for the large types of systems is frequently very different, and it is frequently desired to conceal the automatic nozzles in ceilings and to protect the open nozzles against mechanical impacts. A drawback of concealed nozzles in the ceiling is frequently that the heat sensitive element is shielded completely or partly from the heat impact in the room, and that the open nozzles are provided with a protective jacket which is to be mounted subsequently if the nozzles have been in use.

Water mist nozzles for fire extinction differ from traditional sprinkler and nozzle systems by being able to fight fires with a considerably reduced amount of water, which makes water mist systems for fire extinction attractive in connection with the fire protection of premises where water damage or accumulation of extinguishing water is to be reduced, or where the water supply is poor.

The fine water atomization of the water mist systems causes the water drops to have a relatively large surface relative to their volume, which means that they easily absorb heat from fires and thereby readily evaporate. This costs much heat energy from the fire, which therefore cools the fire and forms large amounts of vapour, which is an inert gas causing suffocation of the fires.

Most water mist systems for fire extinction operate at water pressures of 5,000 kPa-20,000 kPa, where the atomization of the water is achieved by conveying the water at a high pressure through a small hole in the nozzle to the atmosphere. These holes are typically 0.1-0.5 mm in diameter. The high rate at which the water is discharged from the nozzle creates strong air whirls at the outlet of the holes, which contributes to pulling the water jet out and atomizing part of the water. Also, the rate and the great pulse with which the water hits the ambient air cause the water jet to be decomposed to a mist of atomized water. At high pressures, a very fine atomization of the water may be achieved with water drops of <0.02 mm.

The water mist nozzle heads frequently consist of several nozzles which are arranged on a convex conical face to give the nozzle heads a greater coverage area. A drawback of the multi nozzle hole method is that this frequently gives a coverage area with a disuniform water coverage in the coverage area. A drawback of the high pressures is that the very small nozzle holes require very fine water filtration, and that the high water pressures have a relatively high consumption of power.

It has been attempted to solve the problem of the power consumption by reducing the water pressure. A known method is to atomize the water by mixing water at a low pressure, typically 300-20,000 kPa, with air under pressure, either atmospheric air under pressure, typically 400 to 2,000 kPa, or an inert gas, like nitrogen, typically 5,000-30,000 kPa, and to distribute the mixture from a nozzle head having one or more bores. The water is atomized here when the gas expands in the mouth of the nozzle owing to the pressure difference. Like for systems with a high water pressure, a very fine atomization of the water is achieved, but without the holes having to be as small as for systems which operate with high water pressures, and which thereby require a lower water filtration degree.

Like for most systems operating at high water pressures, the nozzle heads are frequently provided with several nozzle holes to give a reasonably large coverage area, and, like for the other nozzle heads, this frequently results in a disuniform distribution of the atomized water and a disuniform water coverage in the coverage area. At the same time, the systems are complicated by the fact that they require both water supply and gas supply. It has been attempted to solve the problem of two supplies in connection with nozzles designed such that nozzles holes, two by two, are arranged at an angle with each other such that the jets from the nozzles hit each other, whereby their energy is converted into atomization of the water.

To achieve a coverage area of a reasonable extent on the nozzle heads, the nozzle heads frequently consist of a multiple of double nozzle holes distributed on a convex conical face. Owing to the many holes which are hereby necessary, these are very small, typically 0.5 mm-1 mm, which requires a good water filtration, and which, also for the other nozzles, gives a non-homogeneous water distribution, because the water tends to distribute itself in jets of atomized water.

It has been attempted to solve the problem of double nozzle holes in connection with nozzles, where a baffle, either in the form of the end of a needle or a ball, etc., is arranged in front of the nozzle hole. A nozzle having a baffle is known e.g. from WO 01544772 A1. In this structure, the water jet hits the baffle, whereby part of the energy is converted into atomization of the water, and part of the energy is spent on sending the water away from the baffle, whereby it hits the water from the nozzle which has not hit the baffle. Hereby, part of the energy of the two jets is converted also into atomizing the water.

In order to distribute the water over slightly larger areas, preferably several nozzle bores are provided, having a baffle in front, round a convex conical face. Like for the other nozzles, multiple nozzle holes cause the coverage area to be disuniform, and the water coverage to be disuniform because of jet formation, as well as increased water concentrations in the areas where the water distribution from the various nozzles merges and continues. Further, it means that the baffle must be kept in position in front of the nozzle hole, preferably by means of a bent needle or rod, or by means of a yoke, an obstacle for the water which is distributed, resulting in a shadow with less water coverage in the coverage area. This frequently means that the water accumulates to larger drops in two or more jets in the periphery of the distribution shadow. Finally, it is required that the baffle is positioned very exactly in front of the nozzle head, both in relation to the centre and in relation to parallelism with the nozzle hole, since, otherwise, this promotes the tendency of distributing water in the form of jets and large drops. This makes the nozzles very vulnerable to mechanical impacts.

### OBJECT OF THE INVENTION

The novelty of the invention is that the mandrel is penetrated by one or more slots or holes, all of which are positioned within the cavity of the cup, and whose total area is larger than the cross-sectional area of the centre hole of the mandrel, and that, outside the periphery of the cup and above the first nozzle, the mandrel comprises a face which forms a fully circular gap between the peripheral face of the cup and the mandrel face, said gap constituting the second nozzle of the liquid atomizer for spreading atomized liquid from the first nozzle in a complete 360° circle.

The invention overcomes the above-mentioned drawbacks and provides a configuration of a liquid atomizer unit which may be incorporated as a liquid atomizer and distributor unit in several types of water mist nozzles for various purposes, and which thus
makes it possible to overcome the mentioned problems of shielding of the heat sensitive elements,
makes it possible to shield the water atomizer unit against mechanical impacts without the use of protective jackets,
gives a uniform and homogeneous coverage of atomized water in coverage areas, and
allows the coverage areas of water mist nozzles to be increased, for water mist nozzles operating at water pressures of 200 kPa to 2,000 kPa.

### DRAWING

An exemplary embodiment of a liquid atomizer unit for fire extinction according to the invention will be described more fully below with reference to the drawing, in which

FIG. 1 shows a liquid atomizer unit for fire extinction according to the invention,

FIG. 2 shows holes and slots in the bottom of the liquid atomizer unit shown in FIG. 1,

FIG. 3 shows alternative holes in the side wall of the liquid atomizer unit shown in FIG. 1,

FIG. 4 shows the liquid atomizer unit shown in FIG. 1, arranged in a nozzle housing,

FIG. 5 shows the liquid atomizer unit shown in FIG. 1 as part of a heat-released liquid nozzle for filled pipe systems,

FIG. 6 shows the liquid atomizer unit shown in FIG. 1 as part of an open liquid mist nozzle for dry pipe systems, and

FIG. 7 shows the liquid atomizer unit shown in FIG. 1 with an integrated liquid connection gate.

### DESCRIPTION OF EXEMPLARY EMBODIMENT

The invention consists in a liquid atomizer unit of metal for incorporation in water mist fire protection nozzles.

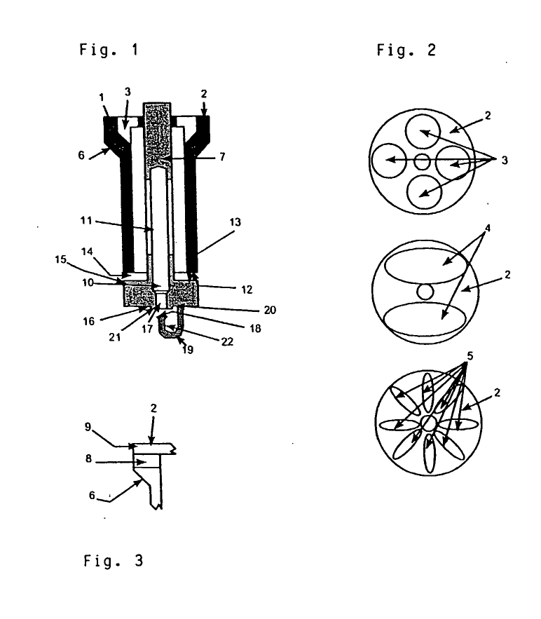

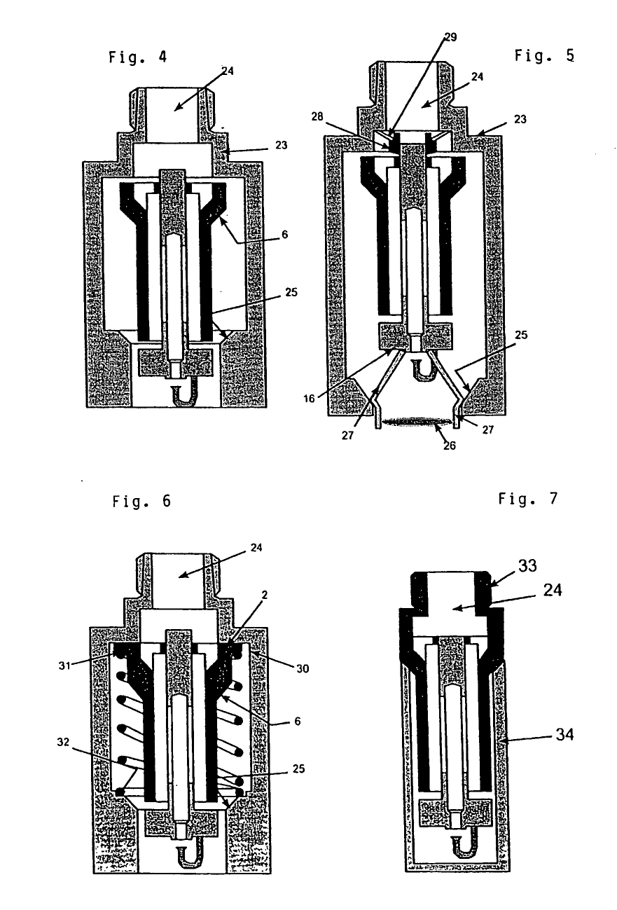

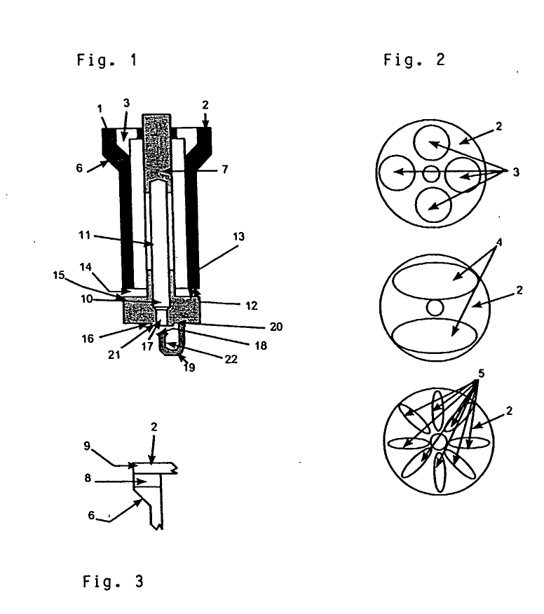

The novelty of the invention is that it consists of a cup 1 with a bottom 2 (see FIG. 1), where the bottom 2 may be penetrated by holes 3 or one or more grooves 4, 5 (see FIG. 2), and an outer face containing a convex conical face 6 with an angle of between 20° and 130°, and the ratio of the longitudinally sectional area to the cross-sectional area of the cavity of the cup is 0.10-0.20. Instead of being arranged in the bottom 2 of the cup, holes or slots 8 may be arranged on the side face of the cup over the conical member 9 (see FIG. 3). The holes or the slots 8 have an area of between 0.50 and 0.90 relative to the hole cross-sectional area of the cup.

The cup 1 contains a mandrel 7 which extends through the cavity of the cup. The mandrel 7 has a centre hole 10. The mandrel 7 is penetrated by one or more slots or holes 11 which are positioned within the cavity of the cup. The total area of these slots or holes 11 is larger than the cross-sectional area of the bore of the mandrel and extends over a length of more than 2× the diameter of the bore of the cup.

Outside the periphery 12 of the cup the mandrel 7 expands and forms a face 13 whose cross-sectional area is larger than the cross-sectional area of the cup hole and a diameter which is 70% to 130% of the diameter of the outer periphery of the cup. The face 13 forms a gap 14 between the peripheral face 12 of the cup and the mandrel face 13 which is between 0.1 mm and 2 mm wide.

The peripheral edge 15 of the mandrel may be 45° to 90°, depending on the requirement with respect to the distribution of the extinguisher. The end 16 of the mandrel is formed with an elevation 21 having a central hole 17 with a diameter of 0.1 to 0.7 relative to the centre hole 10 of the mandrel which connects the centre hole 10 of the mandrel to the atmosphere. The distance between the periphery of the elevation 21 and the periphery of the bore 17 does not exceed 5 mm. The elevation is at least 1 mm high.

A face 18 having an area of 0.1 to 1 relative to the area of the centre hole 17 is provided in front of the centre hole 10 on the central shaft of the hole at a distance of 1 mm-5 mm. This face 18 is parallel with the hole 10. The face 18 is present on a leg 19 which has a cross-section equal to or smaller than the cross-section of the face, and which is secured to the mandrel 7 at a point 20 which is spaced a distance from the face 18 at least 2× the diameter of the face. The face 18 may either be present on a straight section or a rounded section having a diameter larger than the diameter of the face, or on a yoke having two legs (not shown in the drawing).

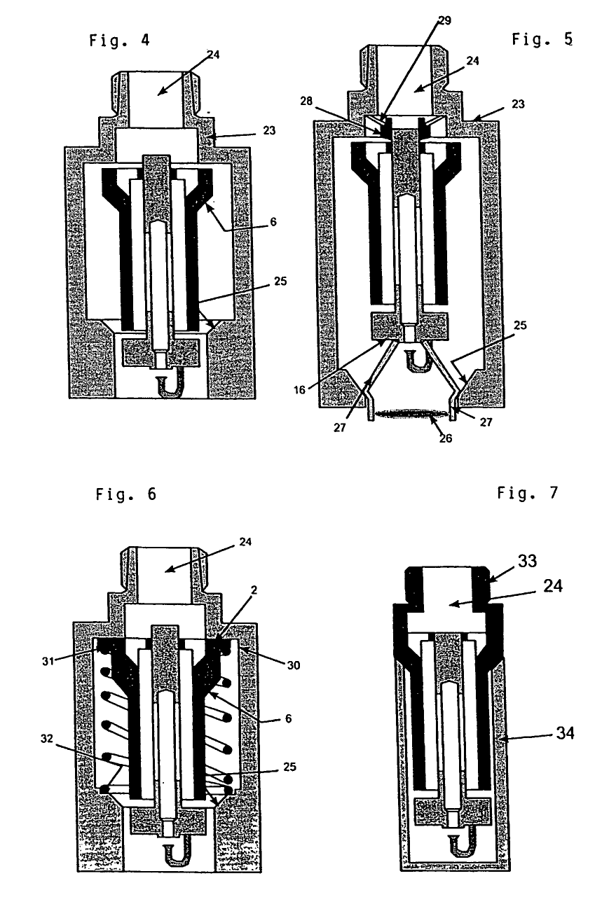

When the invention is arranged in the cavity in a nozzle housing 23 (see FIG. 4) with a water connection gate 24 and a concave conical face 25 having a smallest diameter smaller than the largest diameter over the conical face 6 of the invention and a conical angle larger than or equal to the conical angle of the invention, the cone of the nozzle housing will prevent the cup 1 from dropping out of the nozzle housing 23, and it wall centre the cup 1 in the centre line of the nozzle housing, and the two cones will seal against each other, if water pressure is applied to the water connection gate 24 of the nozzle housing and presses through it on the bottom face 2 of the cup. Liquid will flow through the connection gate 24 of the nozzle housing, if it is not sealed, and the liquid pressure will press the two conical faces 6, 25 together, thereby providing a seal against leakage between the two conical faces 6, 25. Hereby, most of the cup 1 with the nozzle gap 14 and the nozzle bore 17 is completely free of the nozzle housing 23. Liquid will flow through the holes or the gaps 3, 8 in the cup 1 and into the cavity of the cup. Because of a limited gap width 14 between the mandrel face 13 and the peripheral face 12 of the cup a relatively high liquid pressure is provided in the cavity. This causes liquid to flow into the centre hole 10 of the mandrel via the holes 11 in the mandrel 7. Liquid flows through the mandrel 7 and out of the smaller hole 17 in the mouth of the mandrel. The size of the hole 17 is adjusted such that the liquid pressure in the cavity of the cup remains relatively high.

The length and diameter ratio between the length and the cross-section of the cup hole is dimensioned such that the liquid pressure on the entire mandrel face 13 is homogeneous, which causes liquid to be distributed in an undisturbed homogeneous distribution in an entire 360° circle from the nozzle gap 14 at a relatively high rate and in a relatively thin liquid film, which is decomposed to small drops relatively rapidly which may be distributed over great distances in the entire circle around the nozzle. Adjustment of the angle of the mandrel edge 15 allows control of the angle of the liquid distribution angle of the nozzle relative to the shaft direction of the nozzle. The holes 11 in the mandrel 7 are adjusted such that the liquid flow along the mandrel 7 in the cavity of the cup does not cause generation of whirls in the liquid around the mandrel 7, which will reduce the liquid pressure in the cavity of the mandrel and thereby reduce the mouth velocity of the liquid that flows through the hole 17 in the central shaft of the mandrel.

When the liquid flows out of the bore 17, turbulence is created around the jet, which is amplified to some extent by the elevation 21. This means that liquid leaves the bore in a conical jet. The central part of the jet hits the face 18 in front of the bore. The distance between the mouth 17 of the bore and the face 18 is adapted such that the jet has the optimum velocity and the optimum cross-sectional area relative to the face 18 when it hits the face 18, whereby the central part of the jet from the bore 17 hits the face 18. Liquid is hereby pressed out to all sides from the face as a plane circular jet which merges with liquid passing the face 18, whereby part of the energy is converted into the creation of water droplets.

The distance 22 and the distance to the attachment point 20 from the face 18 to obstruct the liquid distribution are adapted to reduce the creation of larger drops and reduce shadow effects in the spray picture from the nozzle. The co-action between the nozzle gap 14 and the nozzle bore 17 with the face 18 is that the nozzle gap 14 supplies liquid mist to cover the large area, while the nozzle bore 17 with the face 18 supplies liquid mist to the area directly below the nozzle.

The air turbulences that occur around the liquid atomizer nozzle when liquid is distributed from the gap 14 and the bore 17 mean that the liquid distribution from the gap 14 smoothens the liquid distribution from the bore 15 and automatically compensates for missing liquid coverage in shadow areas such that the liquid atomizer unit distributes a homogeneous distribution of liquid droplets over a very large coverage area, with slightly larger water drops in the outermost periphery. This is an advantage, because it causes the walls to be wetted slightly more than for traditional water mist systems, which reduces the risk of fire spreading along the walls, without this causing major damage.

FIG. 5 shows the invention as part of an automatic water mist nozzle with a thermal release element 26 which holds two fingers 27 against the conical face 25 in a nozzle housing 23, whereby the fingers 27 press against the end face 16 of the mandrel and are fixed by the elevation 21 at the outlet of the nozzle bore 17. The fingers 27 transfer a force via the mandrel 7 for adjustment of the screw 28, which is connected with the top of the cup 2 and which transfers a force to a disc spring with gasket material 29, which seals the water connection gate 24 of the nozzle housing. This nozzle structure is called an automatic nozzle and is installed in liquid-filled pressurized pipe systems for fire protection. When the heat from a fire releases the heat sensitive element 26, the legs are relieved, whereby the liquid pressure from the pipe system automatically presses the disc spring away from the connection gate 24 of the nozzle, whereby liquid flows into the nozzle housing 23 from which liquid is distributed by the liquid atomizer unit, as described before.

FIG. 6 shows a nozzle housing 30 in whose cavity the liquid atomizer unit is fixed with a compression spring such that the compression spring rests on a shoulder face 31 on the liquid atomizer unit and on the inner side 32 of the nozzle housing 30. When a liquid pressure is applied to the inlet gate 24 of the nozzle housing 30, the force from the liquid supply, which acts on the top of the cup 2, will be greater than the force of the spring, whereby the spring is compressed and the atomizer nozzle of the liquid atomizer unit is exposed from the nozzle housing, and the conical face 6 of the liquid atomizer unit will rest on the conical face 25 of the nozzle housing, where, as mentioned before, a seal is created, and, as mentioned before, the atomizer unit will distribute atomized water in the area around the atomizer unit.

The distance between the cone engagement point on the liquid atomizer unit and the shoulder face 31 is greater than the length of the compressed compression spring. When the liquid pressure is removed from the inlet gate 24 of the nozzle housing 30 again, the force of the liquid on the liquid atomizer unit disappears, and the spring force from the compression spring presses the atomizer unit back again against the rear wall of the nozzle housing 30, whereby the nozzle system of the liquid atomizer unit is automatically pulled back into the nozzle housing 30, where it is protected.

FIG. 7 shows a liquid atomizer unit, where the cup I has been extended by a chamber 24 whose outer wall 33 is provided with a pipe connection, which may be in the form of threads or a flange. In this case, the liquid atomizer nozzle may be connected directly to a supply, following which the liquid atomizer unit will distribute atomized liquid, as already described. In this case, the liquid atomizer unit may be provided with a jacket 34, which protects the unit, and which automatically drops off because of the liquid pressure when the nozzle is activated.

1. A liquid atomizer unit having a double nozzle system for fire extinction, comprising a cup (1) with a bottom (2), said cup (1) containing a mandrel (7) which extends through the cavity of the cup, said mandrel (7) comprising a centre hole (10) as well as an end (16) comprising an elevation (21) with a central hole (17) connecting the centre hole (10) of the mandrel to the atmosphere, a baffle (18) being arranged on the central shaft of the centre hole in front of and in parallel with the centre hole (10), said baffle (18) being disposed on a leg (19) and constituting, in combination with the centrally located hole (17), one nozzle of the liquid atomizer for liquid atomization, characterized in that the mandrel (7) is penetrated by one or more slots or holes (11), all of which are positioned within the cavity of the cup, and whose total area is larger than the cross-sectional area of the centre hole (10) of the mandrel, and that, outside the periphery (12) of the cup and above the first nozzle, the mandrel (7) comprises a face (13) which forms a fully circular gap (14) between the peripheral face (12) of the cup and the mandrel face (13), said gap (14) constituting the second nozzle of the liquid atomizer for spreading atomized liquid from the first nozzle in an entire 3600 circle.

2. A liquid atomizer unit according to claim 1, characterized in that the face (13) is present on a leg (19) which is secured to the mandrel (7) at a point (20), said point (20) being spaced a distance from the face (13) of at least 2× the diameter of the face (13).

3. A liquid atomizer unit according to claim 1 or 2, characterized in that the face (13) has a diameter which is 70% to 130% of the diameter of the outer periphery of the cup (1).

4. A liquid atomizer unit according to claim 1, characterized in that the slots or holes (11) of the mandrel extend over a length of more than 2× the diameter of the bore of the cup.

5. A liquid atomizer unit according to claim 1, characterized in that a ratio of the longitudinally sectional area to the cross-sectional area of the cavity of the cup is 0.10-0.20.

6. A liquid atomizer unit according to claim 1, characterized in that the cup (1) comprises an outer face which contains a convex conical face (6) with an angle of between 20° and 130°.

7. A liquid atomizer unit according to claim 1, characterized in that the bottom (2) is penetrated by holes (3) or one or more grooves (4, 5), or that, as an alternative to this, holes or slots (8) are provided on the side face of the cup over the conical member (9).

8. A liquid atomizer unit according to claim 1, characterized in that the unit is mounted in a nozzle housing (23) having a water connection gate (24), said nozzle housing (23) comprising a concave conical face (25) for cooperation with the conical face (6) of the liquid atomizer thus comprising a smaller diameter than the largest diameter over the conical face (6) of the liquid atomizer and a conical angle greater than or equal to the conical angle of the liquid atomizer.

9. A liquid atomizer unit according to claim 8, characterized in that the unit is secured in the nozzle housing (23) by legs (27) which press against the end face (16) of the mandrel and are fixed by the elevation (21) at the outlet of the nozzle bore (17), said legs (27) being held against the conical face (25) in the nozzle housing (23) by a thermal release element (26) arranged at an angle of 0°-90° relative to the longitudinal shaft of the liquid atomizer unit.

10. A liquid atomizer unit according to claim 8. characterized in that the unit is fixed in the nozzle housing (30) by a compression spring which rests on a shoulder face (31) on the liquid atomizer unit and on the inner side (32) of the nozzle housing (30).
